(19) United States
(12) Patent Application Publication
(10) Pub. No.: US 2004/0129495 A1
(43) Pub. Date: Jul. 8, 2004

(54) Step stool

(75) Inventors: Thomas Lamerson, Verona, WI (US); Michael R. Webb, Hubertus, WI (US); Richard C. Kochanski, Waldo, WI (US); Gene Gladkov, New Berlin, WI (US); Robert D. Heckel II, Eagle River, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(73) Assignee: RDH Investments, LLC, Eagle River, WI

(21) Appl. No.: 10/338,489

(22) Filed: Jan. 8, 2003

(51) Int. Cl. E06C 1/00

(52) U.S. Cl. 182/33

(57) ABSTRACT

A multipurpose step stool includes two substantially parallel, congruent, triangular side support members. The triangular side support members each include first, second, and third resting edges adapted to contact a supporting surface such as a floor. The first treads are oriented parallel to the first resting edges, the second treads are oriented parallel to the second resting edges, and the platform is oriented parallel to the third resting edges. The angle between the first and second resting edges, and the positioning of the first and second treads are selected such that, when the first resting edges are placed on a support surface, a first orientation of the step stool is provided with the first and second treads in combination forming a first rise over run ratio; when the second resting edges are placed on a support surface, a second orientation of the step stool is provided with the second and first treads in combination forming a second rise over run ratio; and when the third resting edges are placed on a support surface, a third orientation of the step stool is provided with the platform elevated above the supporting surface.

### FIELD OF THE INVENTION

The present invention relates generally to portable devices that may be used, among other things, to elevate a user to assist in the performance of certain tasks, to assist a user in reaching elevated places or items, and to support a user while standing or sitting on the device. More specifically, the present invention relates to a multipurpose step stool that allows the user to variably adjust the height of elevation by rotation and selective orientation of the step stool.

### BACKGROUND OF THE INVENTION

Step stools and the like are well known. Indeed, it is common knowledge that a simple step stool can be an indispensable tool in helping an individual to complete daily tasks around the home, in the yard or at work. A step stool may be used to bring the user within reaching distance of an elevated place or object, and may even be used to reduce the user's exertion in reaching for an object that may not necessarily be out of reach. Depending upon what is desired or required by the user, the height to be obtained by the use of the step stool needs to be variable. Similarly, the step stool itself should allow the user to reach a variety of heights to maximize its usefulness. In the view of these inventors, what is needed is a new and useful step stool that is suitable for use in a wide variety of domestic and industrial applications.

### SUMMARY OF THE INVENTION

The present invention provides a new and useful step stool that includes a pair of side support members, each side support member having a plurality of resting surfaces defined within it. In use, each side support member lies in a plane that is generally parallel to the plane that the other side support member lies in. A plurality of combination tread/riser members is provided, each tread/riser member being attachable to and extending generally perpendicularly between the side support members. In this fashion, a first orientation of the step stool provides a first level of elevation, a second orientation of the step stool (having a first rise over run ratio) provides a second, and multiple, level of elevation, and a third orientation of the step stool (having a second rise over run ratio) provides a third, and multiple, level of elevation. Each orientation and each level of elevation is attainable with the use of this single step stool device.

In the preferred embodiment of the step stool that is constructed in accordance with the present invention, the side support members and the combination tread/riser members are detachable from one another, to facilitate manufacturing, and to allow the step stool to be “knocked-down” flat for shipping and storage. In some versions of this embodiment of the invention, the side support members and the combination tread/riser members include integral interlocking latches and latch openings that are functionally adapted for connecting the tread/riser members to the side support members without using tools. Alternatively, more permanent fastening means may be used such as screws or nuts and bolts. The step stool of the present invention can be produced in many forms, adaptable to a wide range of uses. The step stool may be fabricated from a wide range of metallic and nonmetallic materials, material selection not being a limitation of the present invention. The step stool of the present invention is also adaptable to a wide range of sizes, including tall stools having three or more steps, and smaller, perhaps half scale, stools made specifically for children, size not being a limitation of the present invention either.

Other aspects and advantages of the new and useful step stool will be apparent to those having skill in the art upon review of the attached drawings and the following detailed description.

### BRIEF DESCRIPTION OF THE DRAWINGS

FIG. 1 is a top, left and front perspective view of a step stool constructed in accordance with the present invention and showing the step stool as it would be placed on a support surface in a first orientation to provide a first elevation.

FIG. 2 is another perspective view of the step stool illustrated in FIG. 1 and showing the step stool as it would be placed on the support surface in a second orientation providing a first tread/riser ratio.

FIG. 3 is yet another perspective view of the step stool illustrated in FIG. 1 and showing the step stool as it would be placed on a support surface in a third orientation providing a second tread/riser ration.

FIGS. 4A and 4B are schematic diagrams of the generally triangular side support members corresponding respectively to the first and second orientations of the step stool shown in FIGS. 2 and 3, respectively, and illustrating the first and second Rise/Run ratios thereof.

FIG. 5 illustrates one of a pair of the generally triangular side support members from an embodiment of the invention in which the combination tread/riser members are detachable from the side members by used of conventional fasteners.

FIG. 6 is a perspective view of one of the tread/riser members that is shown molded as one piece.

### DETAILED DESCRIPTION

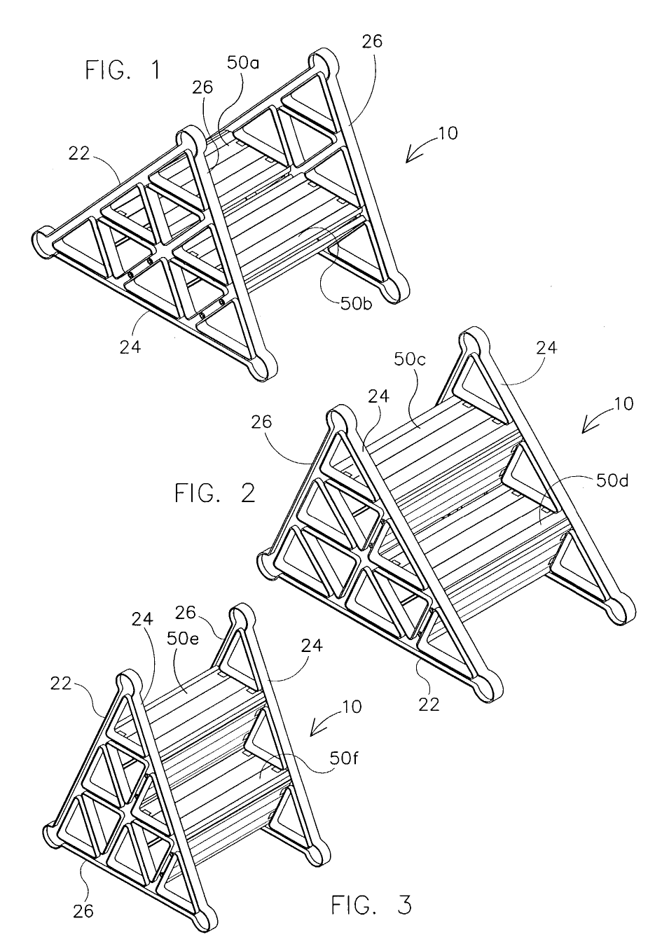

Referring now to the drawings in detail wherein like numbered elements represent like elements throughout, FIG. 1 shows a preferred embodiment of a step stool, generally identified 10, constructed in accordance with the present invention. FIGS. 1, 2 and 3 show the step stool 10 as it would rest in a first, second and third orientation on a support surface such as a floor.

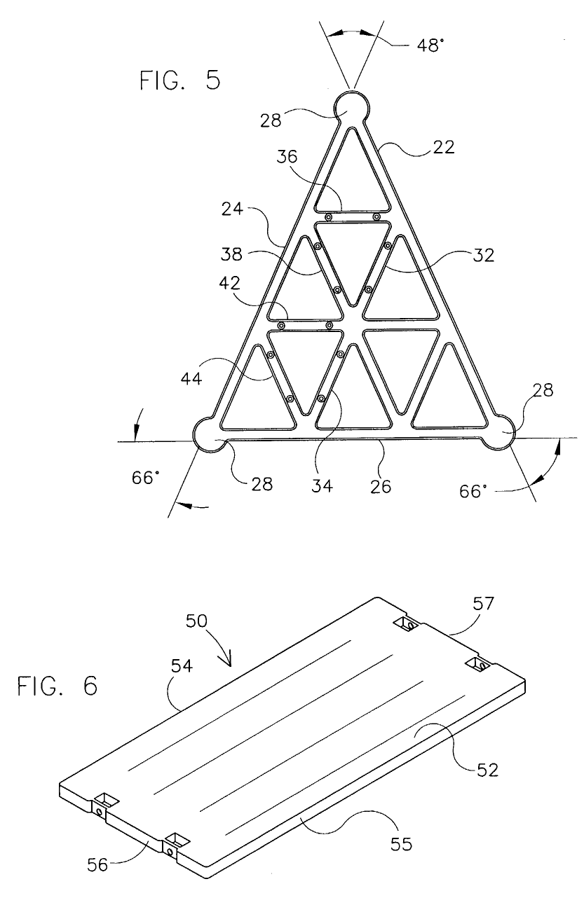

The step stool 10 includes a plurality of tread/riser units, generally identified 50, fastened between a pair of identically configured side support members 20. In the preferred embodiment of the device of the present invention, each side support member 20 is constructed in the form of a generally triangular frame having a plurality of integrally formed and intersecting I-beam type members. See FIG. 5. Specifically, each side support member 20 includes a first outer leg member 22, a second outer leg member 24 and a third outer leg member 26. The first and second outer leg members 22, 24 have the same length and form two sides of an isosceles triangle. The third outer leg member 26 forms the base of the triangle. The acute angle formed by first and second outer leg members 22, 24 is about 48° in the preferred embodiment. The acute angles formed by the first and third outer leg members 22, 26 and by the second and third outer leg members 24, 26 is about 66°. See FIG. 5. It is to be understood, however, that these angles could be varied and are not a limitation of the present invention. It is also to be understood that the outer leg members could be pivotally movable and/or foldable relative to one another as will become apparent later in this detailed description.

A number of inner support members 32, 34, 36, 38, 42, 44 are also provided. Each inner support member 32, 34, 36, 38, 42, 44 is integrally formed as part of the side support member 20 and intersects one of the outer leg members 22, 24, 26. See FIG. 5. In the preferred embodiment, each inner support member 32, 34, 36, 38, 42, 44 is formed in an I-beam cross-section configuration. As shown, the inner support members 32, 34, 36, 38, 42, 44 each form a part of a generally hexagonal support structure. Also as shown, the inner support members 32, 34 are generally collinear. The inner support members 36, 42 are generally parallel to one another as are the inner support members 38, 44. The purpose and function of this configuration will become apparent further in this detailed description.

In the preferred embodiment, a plurality of tread/riser members, generally identified 50, are provided. See FIG. 6. Each tread/riser member 50 has an upper surface 52, a pair of side edges 54, 55 and a pair of end edges 56, 57. The end edges 56, 57 are those portions of the tread/riser members 50 that are engageable with the side support members 20, and the inner support members 32, 34, 36, 38, 42, 44 thereof in particular.

Referring again to FIG. 1, a first pair of generally planar tread/riser members 50a, 50b are oriented generally parallel to a plane formed by the second outer leg member 24 of each side support member 20. Referring to FIG. 2, a second pair of tread/riser members 50c, 50d are oriented generally parallel to a plane formed by the first outer leg member 22. And referring to FIG. 3, a third pair of tread/riser members 50e, 50f are shown oriented generally parallel to a plane formed by the third outer leg member 26 of each side support member 20.

As shown in FIGS. 2 and 3, the tread/riser members 50c, 50d and 50e, 50f, respectively, are staggered one from the other. In the embodiment depicted in FIGS. 1 through 4B, the first and third outer leg members 22, 26 form an acute angle with each other, and the riser/tread members 50c, 50d, used as treads, are spaced from a point of intersection 27 of projections of the first and third surfaces 22, 26, such that when the step stool 10 is resting in the second orientation, the tread/risers 50e, 50f form risers for the treads 50c, 50d. This combination forms a first rise over run ratio Rise₁/Run₁, which is relatively flat and suitable, for example, in assisting small children to reach important areas such as sinks and toilets.

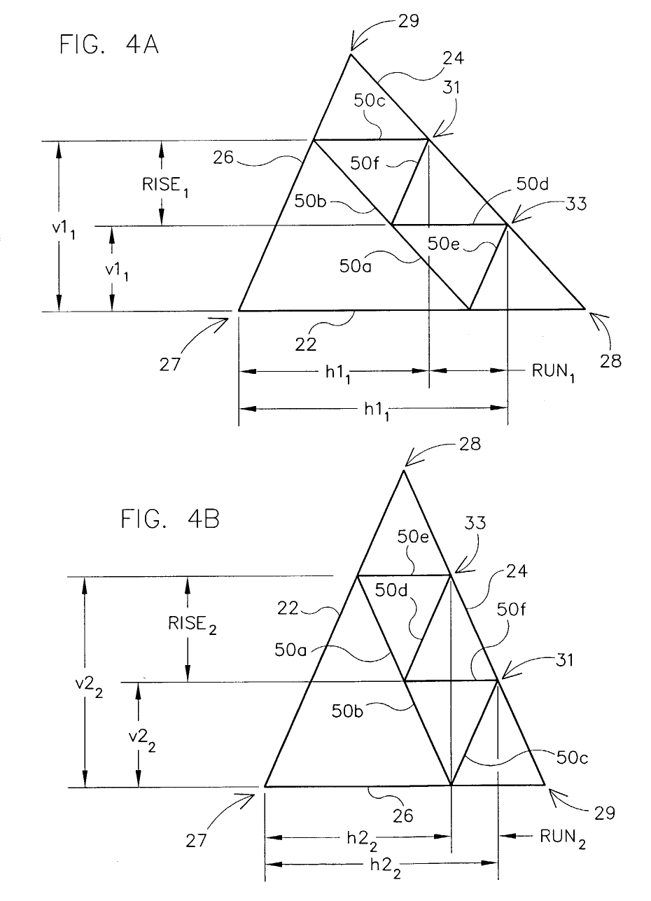

When the step stool 10 is positioned in the third orientation, as depicted in FIGS. 3 and 4B, with the third outer leg 26 in contact with a supporting surface, the treads 50c, 50d form risers to the treads 50e, 50f. This combination forms a second rise over ratio Rise₂/Run₂ that is steeper than the first rise over run ratio Rise₁/Run₁, thereby allowing the user to climb to a height suitable for reaching high spots such as the upper corners of a room or the tops of tall furniture or shelving.

In the embodiments depicted in FIGS. 1 through 3, the first, second and third outer leg members 22, 24, 26, which are also resting surfaces for the stool 10, extend almost the full length of the sides of the triangular side support members 20 and intersect with one another in rounded corners 28, rather than being truncated or cut off. Extending the resting surfaces 22, 24, 26 in this fashion provides increased stability in any of the first, second or third orientations, and also provides a grip rail extending above the treads and platform for the user to grasp while ascending or standing on the treads 50. This is particularly true where the cross-sectioned construction of each outer leg member 22, 24, 26 is in the form of an I-beam as previously described.

As shown in FIG. 4A, the first rise over run ratio Rise₁/Run₁ is calculated by projecting the first and third resting surfaces 22, 26 to a point of intersection 27 beyond the rounded corner 28, and dividing the difference in vertical distances v1₁, v1₂ (from the point of intersection 27 of the first and third resting surfaces 22, 26 to points of intersection 31, 33 of a projection of the working surfaces of the treads 50c, 50d) by the difference in horizontal distances h1₁, h1₂ (from the point of intersection 27 of the first and third resting surfaces 22, 26 to the points of intersection 31, 33 of the projections of the working surfaces of the treads 50c, 50d).

The second rise over run ratio Rise₂/Run₂ is calculated in similar fashion, as shown in FIG. 4B, by utilizing the vertical and horizontal distances v2₁, v2₂, h2₁, h2₂, from the point of intersection 27 of the projections of the first and second resting surfaces 22, 26 to the points of intersection 31, 33 of the projections of the treads 50e, 50f.

In some forms of the step stool 10 of the present invention, it may be advantageous to have some of the component parts, i.e., the treads 50, or the side support members 20, integrally joined together in an inseparable unit. In other forms of the step stool 10, however, it may be advantageous to have some or all of the components of the step stool 10 be detachable from the other components to facilitate manufacturing, shipping, or storage of the step stool 10. FIGS. 5 and 6 depict an embodiment of the step stool 10 having a pair of identical side support members 20 (only one shown) that are detachable from a series of identical tread units 50 (only one shown) that can be positioned and attached to the side support members 20 as previously described. In this fashion, the first pair of tread/riser members 50a, 50b are removably attachable to the inner support members 32, 34, respectively, of the side support members 20. The second pair of tread/riser members 50c, 50d are similarly removably attachable to the inner support members 44, 38, respectively, of the side support members 20. And the third pair of tread/riser members 50e, 50f are removably attachable to the inner support members 36, 42, respectively. It is to be understood that each riser/tread member 50 is attachable to each side support member 20 by use of conventional fastening means. In this fashion, and with this configuration, the second pair of tread/riser members 50c, 50d serve as the risers for the third pair of tread/riser members 50e, 50f when those members are used as treads and vice versa.

The device of the present invention can also be fabricated to be fully collapsible along outer leg member 24. In this embodiment, each joint 31, 33 is actually two joints. For example, tread/riser member 50e would have a revolute joint 33 with respect to member 24 whereby member 50e is permitted to rotate about that joint 33. At that same joint 33, tread/riser member 50d is permitted to slide along the outer let member 24 and also is permitted to revolve. In this manner, and as member 50d slides downwardly along the outer leg member 24, member 50a is drawn towards the outer leg member 24 until member 50a is flush with the outer leg member 24.

Similarly, member 50f has a revolute joint 31 with respect to the outer leg member 24. Member 50c has a sliding and revolute relationship with member 24. Thus, as member 50f revolves, member 50c slides along member 24 until member 50b is substantially flush with member 24.

Obviously, the step 10 of the present invention stool is required to be a static structure. Therefore, some simple means of transforming the structure from a step stool to a reasonably flat object is also required. In other words, something must allow for transformation of the stepstool 10 from a static structure to a dynamic structure. To that end, member 22 and member 26 may be attached to one another via a quick release joint 27, of which there are many examples in the art. Member 22 and 24 are also connected via a revolute joint 28, as are members 26 and 24. Therefore, as member 26 is rotated upwardly towards member 24, member 22 is no longer supported outwardly. Therefore, member 22 is permitted to fold toward member 24 causing member 50e to rotate downwardly, also allowing member 50d to slide downwardly and rotate downwardly. Simultaneously, member 50f rotates downwardly and member 50c slides and rotates downwardly. At completion, the entire step stool 10 lies flat against member 24. Now, this description has been given as if the step stool 10 were only two dimensional. The actual step stool 10, is, of course, three dimensional, but the rotating and sliding parts merely extend along the third axes such that the object can be modeled in two dimensions.

As an alternative to conventional fastening means, each riser/tread member 50 may be constructed with integral locking tabs (not shown) having latch surfaces which resiliently slide through matching slots (also not shown) in the side support members 20 in such a manner that the treads 50 and side support members 20 can be connected together without the use of tools. In this manner, the step stool 10 can be readily manufactured and shipped in a flat, knocked-down configuration to save on shipping and inventory costs, and the step stool 10 can be readily assembled by the user upon purchase.

The step stool 10 of the present invention can be fabricated from a wide variety of materials, by a number of methods, and in a number of forms or sizes dependent upon the size of the user, and the nature of the use. In one preferred form of my step stool 10, the side plates and treads as depicted in FIGS. 1 through 3, 5 and 6 could be cast from aluminum or other metal material. They could also be injection molded from a polypropylene material. When such a material is used, it may be desirable to reinforce the intersection of the first, second and third resting surfaces 22, 24, 26, as shown by the partial circular enlargements at reference numeral 28 in FIG. 5. Where such enlargements extend out of the planes defined by the first, second and third resting surfaces 22, 24, 26, stability of the step stool 10 on soft surfaces such as carpet or turf may be enhanced by having the enlargements 28 penetrate the supporting surface slightly.

It is to be understood, therefore, that the scope of the disclosure and appended claims are not limited to the specific embodiments described and depicted herein.

1. A step stool comprising a pair of side support members, each side support member including a first and a second resting surface respectively coplanar with the corresponding first and second resting surface of the other, a first tread extending between said pair of side support members and oriented parallel to said first resting surfaces, and a second tread extending between said pair of side support members and oriented parallel to said second resting surfaces.

2. The step stool of claim 1 wherein projections of said first and second resting surfaces intersect at a point of intersection of said projections.

3. The step stool of claim 2 wherein said first treads are spaced at a first set of vertical and horizontal positions from said first resting surface and said point of intersection, and said second treads are spaced at a second set of vertical and horizontal positions from said second resting surface and said point of intersection.

4. The step stool of claim 2 wherein said first and second resting surfaces intersect at an acute angle.

5. The step stool of claim 2 wherein said first and second treads are coplanar.

6. The step stool of claim 1 comprising a first set of steps including said first tread and one or more additional treads that are parallel to said first resting surfaces.

7. The step stool of claim 6 comprising a second set of steps including said second tread and one or more additional treads parallel to said second resting surface.

8. The step stool of claim 7 wherein each of said pair of side support members includes a third resting surface that is coplanar with the third resting surface of the other, and said step stool includes a third tread parallel to said third resting surface extending between said first and second side support members.

9. The step stool of claim 8 wherein a projection of said third resting surface intersects projections of said first and second resting surfaces.

10. The step stool of claim 7 wherein said side support members are detachable from said first and second treads.

11. The step stool of claim 10 wherein said pair of side support members and treads include interlocking means for removably connecting said treads to said side support members.

12. The step stool of claim 11 wherein said interlocking means are adapted for connecting said treads to said side support members without using tools.

13. The step stool of claim 7 wherein at least two support members are connected via a quick release joint thereby releasing one member to fold upwardly to become coplanar with the third support member and one member urges the inner support members to fold into position such that the step stool is converted to a flat object.

14. A step stool comprising a first side support member including a first and a second resting surface, a second side support member including a first and a second resting surface that is generally coplanar with said first and second resting surfaces of said first side support member, a first set of steps connecting said first and second side support members and having one or more first treads parallel to said first resting surfaces, and a second set of steps connecting said first and second side support members and having one or more second treads parallel to said second resting surfaces.

15. The step stool of claim 14 wherein projections of said first and second resting surfaces of each of said side support members intersect

16. The step stool of claim 14 wherein said first and second side support members each include a coplanar third resting surface, and said step stool includes a third set of one or more third treads parallel to said third resting surfaces.

17. The step stool of claim 14 wherein at least two support members are connected via a quick release joint thereby releasing one member to fold upwardly to become coplanar with the third support member and one member that urges the inner support members to fold into position such that the step stool is converted to a flat object.

18. A step stool comprising two substantially parallel, congruent, triangular side support members, a tread/riser section with first and second treads, and a platform, said triangular side support members having first, second, and third resting edges with said first treads parallel to said first resting edges, said second treads being parallel to said second resting edges, and said platform being parallel to said third resting edges.

19. The step stool of claim 18 wherein said first treads and second treads are spaced respectively from said first and second resting edges such that:
when said first resting edges are placed on a support surface a first orientation of the step stool is provided with said second treads forming risers to said first treads, and said first and second treads form a first tread/riser ratio;
when said second resting edges are placed on a support surface a second orientation of the step stool is provided with said first treads forming risers to said second treads, and said second and first treads forming a second tread/riser ratio; and
when said third resting edges are placed on a support surface a third orientation of the step stool is provided with said platform elevated above said supporting surface.
